(19) United States
(12) Patent Application Publication
(10) Pub. No.: US 2004/0003366 A1
(43) Pub. Date: Jan. 1, 2004

(54) Method for making layout data in semiconductor integrated circuit

(75) Inventor: Kyou Suzuki, Kawasaki-shi (JP)

Correspondence Address: Norman P. Soloway, HAYES SOLOWAY PC, 130 W. Cushing Street, Tucson, AZ, 85701, US

(73) Assignee: NEC Compound Semiconductor Devices, Ltd.

(21) Appl. No.: 10/463,922

(22) Filed: Jun. 18, 2003

(30) Foreign Application Priority Data
Jun. 26, 2002 (JP) 186575/2002

(51) Int. Cl. G06F 17/50

(52) U.S. Cl. 716/11

(57) ABSTRACT

Circuit diagram data having repeated patterns is divided by the process of group dividing into main patterns and replicated patterns, relations of each of the patterns are held as group composition information, replicated pattern layout data corresponding to replicated patterns is made by copying the main pattern layout data corresponding to the main patterns made by a net driven layout editor, and the process of offset arrangement which involves shifting the coordinates of the replicated pattern layout data is performed, thereby making it possible to arrange the replicated pattern layout data on the same hierarchical level as the main pattern layout data and to make layout data with the flat circuit diagram data kept as it is.

### BACKGROUND OF THE INVENTION

1. Field of the Invention

The present invention relates to a method for making layout data in a semiconductor integrated circuit and, more particularly, to a method for making layout data in a semiconductor integrated circuit which can efficiently lay out a circuit having repeated patterns.

2. Description of the Prior Art

It is known well that in recent years, information electronic devices have been constituted by semiconductor integrated circuits. It is also known well that in designing such semiconductor integrated circuits, the making of layout data in semiconductor integrated circuits is important. Among the above-described layout data in semiconductor integrated circuits, the success or failure of a layout of a circuit having repeated patterns is closely related to whether the design of a semiconductor integrated circuit is a success or a failure.

Therefore, a description will be given of a method for making layout data in a circuit in which a semiconductor integrated circuit has such repeated patterns. The diagram in FIG. 1 shows a circuit having repeated patterns.

A semiconductor integrated circuit shown in FIG. 1 has a differential amplifier block 51, which includes transistors Q101 to Q103 and resistors R101, R102, R104, differential amplifier blocks (52, 53) having the similar configuration as the differential amplifier block 51, an output part block 55, which includes transistors (Q401, Q402) and resistors R (401, 402), and an output part block 56 which is similar to the output part block 55.

In the differential amplifier block 53 shown in FIG. 1, the resistance value of the resistor R302 (component 54) is 10 kΩ and hence this differential amplifier block 53 has a flat circuit having a resistance value different from the resistance value of 1 kΩ of other resistors R102, R202.

In a conventional method for making layout data in a circuit having such repeated patterns, processing has been performed by use of a net driven layout editor. The conventional method for making layout data in a circuit having such repeated patterns is disclosed in Japanese patent No.2912284. This net driven layout editor is a tool which builds layout data by generating cell data and wiring data corresponding to connection information (component symbols, connection node numbers, etc.) on the basis of connection information on the circuit diagram data side. The function of this net driven layout editor is such that, when circuit diagram data has a hierarchical structure, corresponding layout data also has the same hierarchical structure. In the layout data which is made, the same connection information as the circuit diagram data which provided the basis is retained.

A method for making layout data of the first conventional example of a circuit having the repeated patterns will be described with reference to the processing flow chart of FIG. 2. An outline of the method for making layout data of the first conventional example is that the repeated pattern areas (51, 52, 53, 55, 56) are regarded as blocks by the hierarchization work of the processing flow and symbolized to obtain circuit diagram data 11 having a hierarchy.

With reference to FIG. 2, in the method for making layout data of the first conventional example, hierarchization work 601 is first performed from the flat circuit diagram data 11 and hierarchical circuit diagram data 31 is made. Subsequently, whether the hierarchized block is an existing one, a new one or a similar one is judged (602). In the case of an existing block, block cell data 32 is not generated. In the case of a new block, block cell data 32 is generated from the hierarchical circuit diagram data 31 by use of a net driven layout editor 603. In the case of a similar block, the existing block cell is copied from the block cell data 32 (604), pattern editing is performed (605), and this is recorded in the block cell data 32. And after block cell data 32 of all types of blocks has been prepared, block cells are arranged from this block cell data 32 (607), a layout is configured (608) and layout data 15a is made.

Concretely, the method for making layout data of the first conventional example will be described below by taking amplifiers as an example. Referring to FIG. 3A to FIG. 3C, in the method for making layout data of the first conventional example, each of the blocks (51, 52), block 53 and blocks (55, 56) of FIG. 3A is caused to correspond to a symbol 71 of Amp-A, a symbol 72 of Amp-B and a symbol 73 of Buffer, respectively, as shown in FIG. 3B, and these blocks are included. in circuit diagram data 74 having a hierarchy as shown in FIG. 3C.

Because the amplifier blocks 51, 52 have the same configuration, they are symbolized as the common symbol 71 of Amp-A and arranged in a hierarchy. Although the amplifier block 53 has a configuration similar to that of the amplifier blocks 51, 52, it provides a component 54 having a different component value. Therefore, this amplifier block 53 is arranged in a hierarchy as the symbol 72 of Amp-B, which is another symbol. Because the blocks 55, 56 of the output circuit have the same configuration, they are arranged in a hierarchy as the symbol 73 of Buffer, which is a common buffer.

In the net driven layout editor 603, as shown in FIG. 4, block cell data 81, 82 is generated for each symbol of the circuit diagram data (71, 72, etc. of FIG. 3A to FIG. 3C and FIG. 4). After that, the layout data 15a is made by arranging the block cell data 81, 82 at a hierarchical level below top cell data 83. Incidentally, in FIG. 4, the portion of the circuit patterns is hatched.

The block cell data 81, 82 corresponding to these symbols 71, 72 is made (the same also applies to the symbol 73). However, the symbol 72 differs from the symbol 71 only in part of the component value of the component 54. In general, therefore, the block cell data 82 is made by copying and partially modifying the block cell data 81. In a case where repeated patterns are similar (similar pattern, 82 in FIG. 4) like this, block cell data is copied and used by modifying different areas (72, 82 in FIG. 4).

Next, FIG. 5 depicts a method for making layout data of the second conventional example. This figure of the method for making layout data of the second conventional example is a flow chart when an ECO function of the net driven layout editor is used in making block cell data corresponding to similar patterns. ECO is an abbreviation for “engineering change orders” and refers to the function of automatically correcting the layout data side in response to changes of component values etc. of a circuit diagram. This is a feature extension which a net driven layout editor generally has.

In the method for making layout data of the second conventional example, after the judgment on the similarity of a block, block cell data 32a is made by the ECO function of a net driven layout editor 702. After that, the process of copying of existing block cells 701 is performed simply by copying block cell data from block cell data 32a.

In this case, only the process of block cell copying 701 which involves simply copying the block cell data 32a is performed. Therefore, no coincidence may sometimes exist between the connection information (symbols) on the circuit diagram data side and the connection information of the block cell data 32a. However, the ECO function of the net driven layout editor 702 enables coincidence to exist between the connection information on the circuit diagram data side and the connection information of the block cell data.

In these first and second conventional techniques, in the case of a circuit having repeated patterns, the same patterns are grouped and symbolized as a block (a block symbol). And in terms of efficiency, it is a general practice to make circuit diagram data (a hierarchical circuit diagram) having a hierarchical structure in which these same patterns are arranged at a lower hierarchical level.

In this case, also in the layout data built by the net driven layout editor, block cell data corresponding to block symbols is built and arranged at a lower hierarchical level below a top cell to provide a hierarchical structure similar to that of the hierarchical circuit diagram. Common block cell data is used for the same patterns. FIG. 6 depicts a hierarchical structure.

More specifically, as shown in FIG. 6, each block cell data 81, 82, 92 is arranged at a lower hierarchical level below top cell data 91 of the made layout data 15a. The block cell data is the block cell data 81 of two individual symbols Amp-A, the block cell data 82 of Amp-B and the block cell data 92 of Buffer. The two individual symbols Amp-A provide areas corresponding to the circuits 51, 52 and form the common block cell data 81. Incidentally, in terms of a hierarchical structure, the same applies also to-circuit diagram data.

On the other hand, when layout data is built by use of circuit diagram data in which all components are arranged at the same hierarchical level (a flat circuit diagram), it follows that also layout patterns corresponding to the same pattern (block) are built at the same hierarchical level. However, even in the case of the same pattern, cell data and wiring data corresponding to blocks are not common to each other (that is, the cell data and the wiring data are not the same data) Therefore, these data must be individually made and the efficiency is very low.

In the above-described prior art, however, it becomes difficult to grasp the operation of a circuit when circuit data is made to have a hierarchical structure in consideration of the efficiency of layout. This is remarkable especially in the case of an analog system. Furthermore, in the case of flat circuit diagram data which enables the operation of a circuit to be easily grasped, corresponding layout data also becomes flat. Therefore, repeated pattern areas must be individually made, posing the mutually contradictory problem that redundant work becomes necessary.

The reason why such a problem arises is that the net driven layout editor builds layout data by generating cell data and wiring data corresponding to the connection information on the circuit diagram data side. As a result, in the case of a circuit having repeated patterns, in checking the flow of electrical signals on each component and wiring in circuit design, it is necessary to move up and down between the upper and lower levels of a hierarchical structure. That is, it becomes difficult to grasp the operation of the whole circuit. In particular, in an analog system, the efficiency is low when circuit design is performed by use of a hierarchical structure.

In contrast, in the case of layout design, data is made for each pattern when a flat structure is used. Therefore, even when one pattern is corrected, the correction is not reflected in the other pattern (in the case of a hierarchical structure, when one pattern, such as Amp-A, is corrected, the correction is instantaneously reflected also in commonly used patterns) That is, the efficiency of commonality is low in a flat structure, it is advisable to perform layout design by use of a hierarchical structure.

The object of the present invention is to provide a method for making layout data in a semiconductor integrated circuit which solves problems in a flat structure and a hierarchical structure, facilitates the grasping of the operation of the whole circuit, makes a circuit correction easy and eliminates redundant work in layout data making.

### SUMMARY OF THE INVENTION

In a method for making layout data in a semiconductor integrated circuit of the present invention, circuit diagram data having repeated patterns is divided by the process of group dividing into main patterns and replicated patterns, and relations of each of the patterns are held as group composition information. Layout data corresponding to replicated patterns (replicated pattern layout data) is made by copying layout data corresponding to the main patterns made by a net driven layout editor (main pattern layout data). By further performing the process of coordinate off set arrangement, the replicated pattern layout data is arranged on the same hierarchical level as the main pattern layout data.

### BRIEF DESCRIPTION OF THE DRAWINGS

FIG. 1 depicts a circuit block diagram to explain a general layout;

FIG. 2 depicts a processing flow chart to explain a conventional example of layout design method;

FIG. 3A to FIG. 3C depict diagrams to explain the making of layout data 15a from circuit diagram data having a prior art hierarchy;

FIG. 4 depicts an arrangement plan to explain a layout of the first conventional example;

FIG. 5 depicts a flow chart of processing when an ECO function of the second conventional example;

FIG. 6 depicts a hierarchical diagram to explain a prior art hierarchical structure;

FIG. 7 depicts a flow chart to explain the configuration and operation of the first embodiment of the invention;

FIG. 8 depicts a diagram of an example of group construction information (group circuit connection information) in the processing of FIG. 7;

FIG. 9 depicts a processing flow chart of the group dividing (101) in the embodiment of FIG. 7;

FIG. 10 depicts a block diagram of an example of search pattern of FIG. 9;

FIG. 11 depicts a flow chart of processing related to a circuit correction of the second embodiment of the invention;

FIG. 12 depicts a flow chart of processing related to a circuit correction of the third embodiment of the invention;

FIG. 13 depicts a flow chart of an example of composition information update processing of the embodiments of FIGS. 11 and 12;

FIG. 14A depicts a layout plan on the main pattern side to explain the fourth embodiment of the invention;

FIG. 14B depicts a layout plan on the replicated pattern side to explain the fourth embodiment of the invention;

FIG. 15 depicts a diagram of group construction information of the embodiment of FIGS. 14A and 14B;

FIG. 16 depicts a circuit diagram in a case where part of components are partially different from the search pattern to explain the fifth embodiment of the invention; and

FIG. 17 depicts a diagram of group composition information of the embodiment of FIG. 16.

### DESCRIPTION OF THE PREFERRED EMBODIMENTS

Next, embodiments of making layout data in a semiconductor integrated circuit of the present invention will be described in detail by referring to the accompanying drawings.

(First Embodiment)

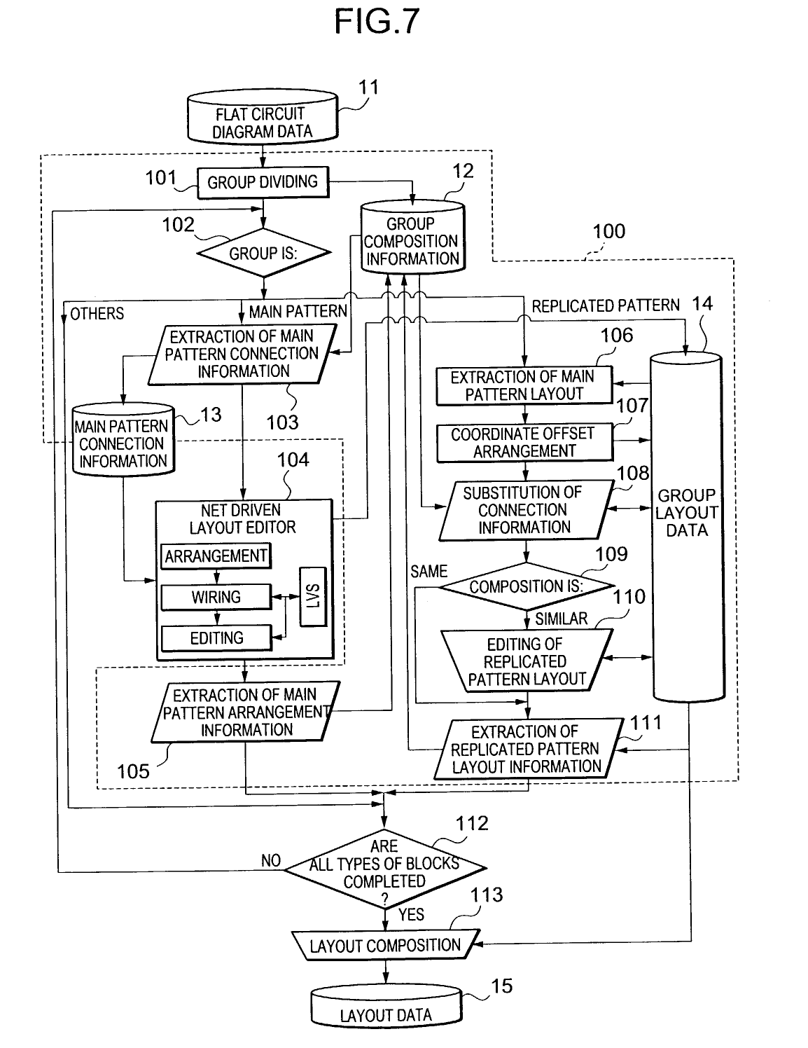

FIG. 7 depicts a processing flow chart to explain a method for making layout data in a semiconductor integrated circuit of the first embodiment of the invention. In the figure, portions which correspond to the features of the invention are indicated by a short dashed line (100).

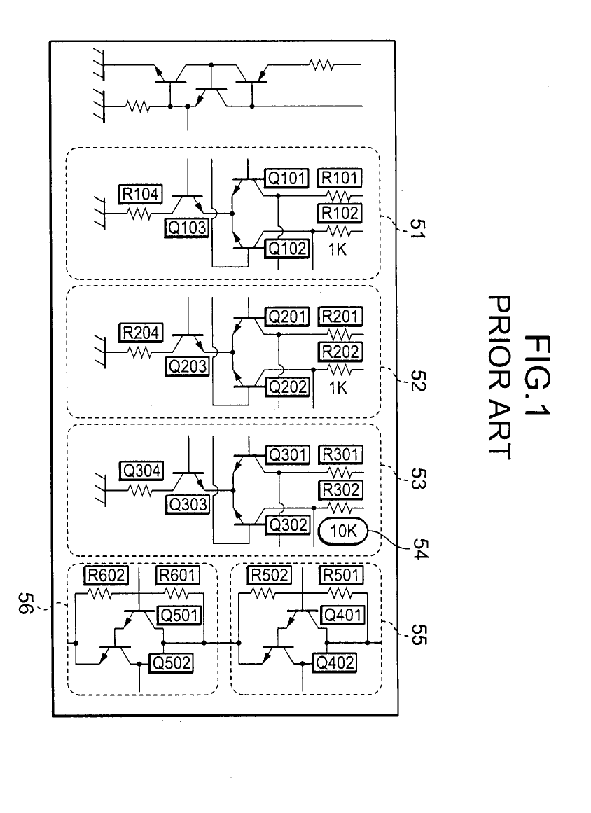

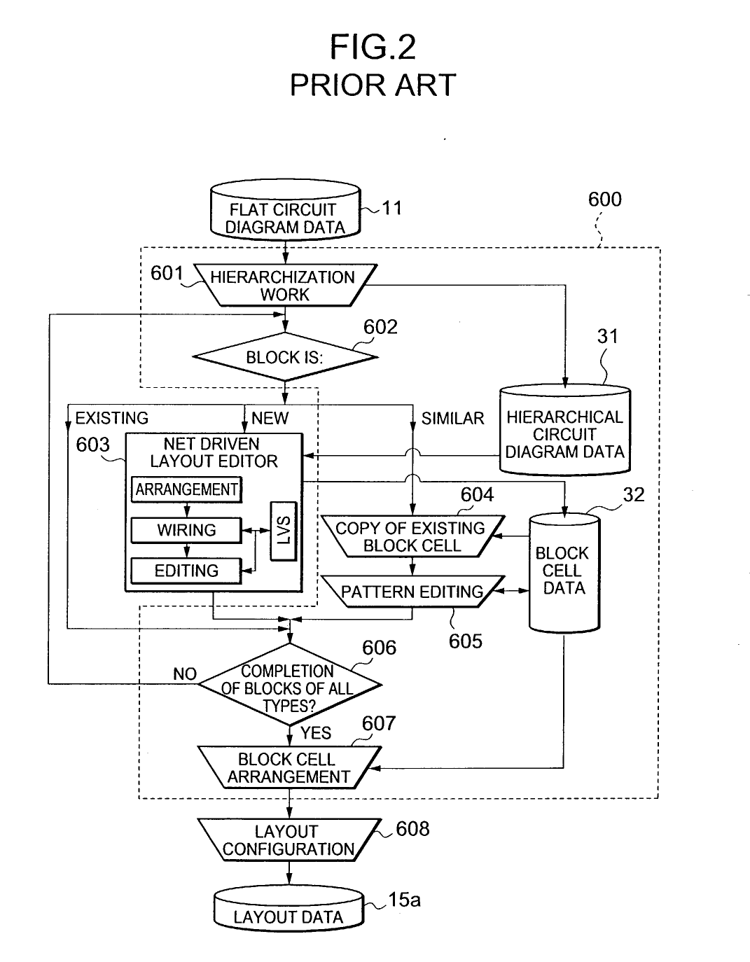

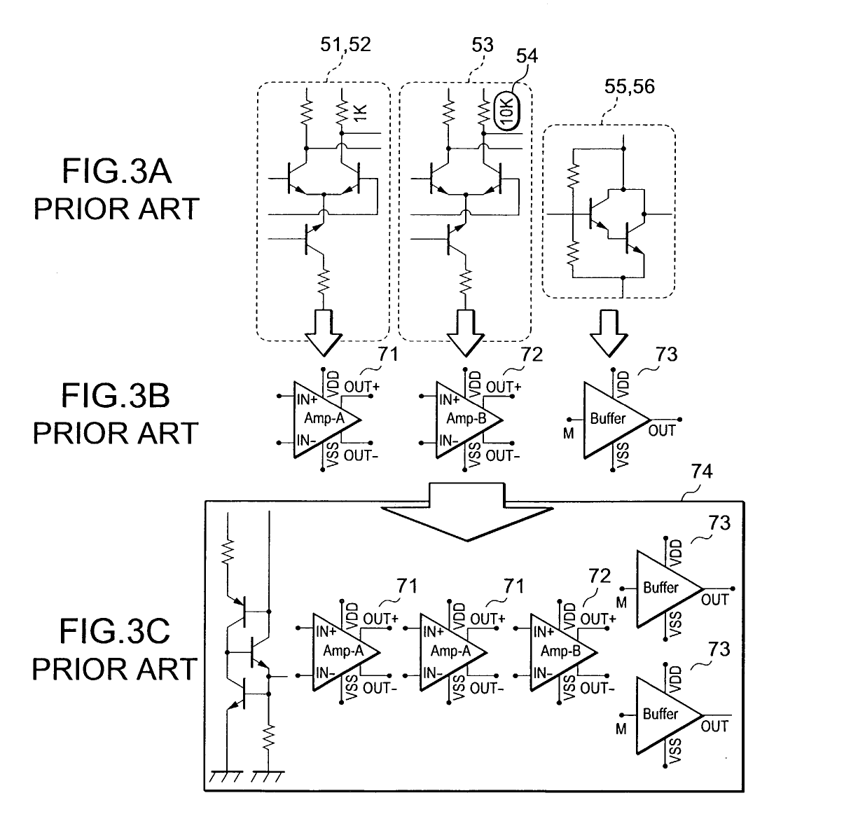

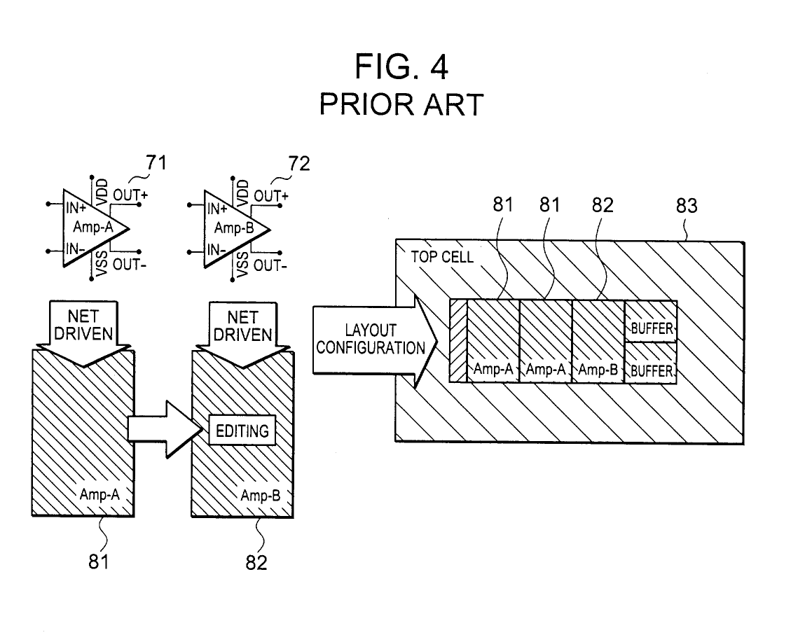

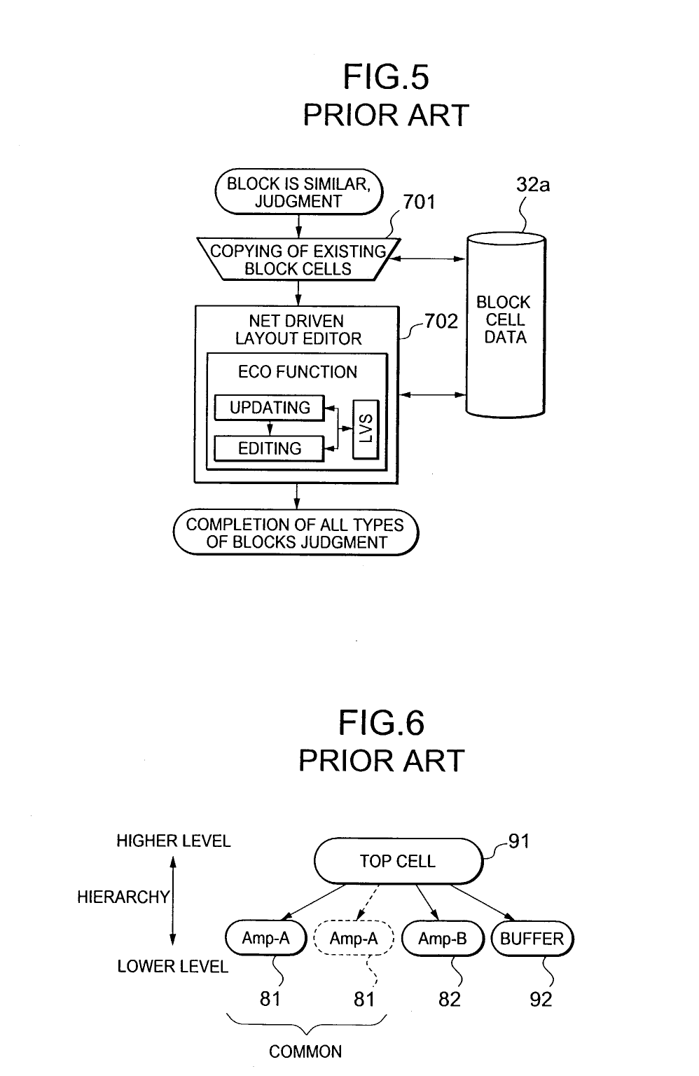

The method for making layout data in a semiconductor integrated circuit of the first embodiment of the invention 100 includes the process of group dividing 101 and the judgment step 102. In the process of group dividing 101, repeated patterns are first divided, from connection information of circuit diagram data (file) 11 of a flat circuit diagram as shown in FIG. 1, into a group of main patterns and a group of replicated patterns obtained by replicating the main patterns and a discrimination is further made between the main patterns and the replicated patterns obtained by replicating the main patterns for the input to group composition information 12. In the judgment step 102, judgment is passed as to whether the information existing in the group composition information 12 is main pattern connection information, replicated pattern connection information or other connection information. Incidentally, replicated patterns are patterns obtained by replicating main patterns and have the same constituent components of circuit diagram data but different connection information of circuit diagram data.

The method for making layout data in a semiconductor integrated circuit of the first embodiment of the invention 100 further includes the process of extraction of main pattern connection information 103 and a net driven layout editor 104. In a case where it is judged in the step 102 that the group composition information 12 is main pattern connection information, in the process of extraction of main pattern connection information 103, corresponding layout data is made from the main pattern connection information present in the group composition information 12 and output to group layout data 14.

Furthermore, there is provided the process of extraction of main pattern arrangement information 105 which involves outputting arrangement information of the made main pattern layout data to the group composition information 12.

In a case where it is judged in the step 102 that the group composition information 12 is replicated pattern connection information, in order to make corresponding layout data from the replicated pattern connection information existing in the group composition information 12, there are provided the process of extraction of main pattern layout 106 which involves shifting (offsetting) the arrangement coordinates of layout data of main patterns to the coordinates for the arrangement of replicated pattern layout data and performing replication arrangement, the process of coordinate offset arrangement 107, and the process of substitution of connection information 108 which involves substituting this layout data connection information subjected to replication arrangement for the replicated pattern connection information.

In a case where the configuration of the replicated pattern layout data is similar, there are provided the process of editing of replicated pattern layout 110 which involves performing correction work and the process of extraction of replicated pattern arrangement information 111 which involves outputting the replicated pattern arrangement information to the group composition information 12. In a case where the configuration of the replicated pattern layout data is the same, the process of editing of replicated pattern layout 110 which involves performing correction work is not performed and instead the process of extraction of replicated pattern arrangement information 111 is performed, which involves outputting the replicated pattern arrangement information to the group composition information 12.

There is provided the process of layout composition 113 to obtain layout data 15 by composing layout data of other patterns etc. after the above processing has been completed for all types of pattern.

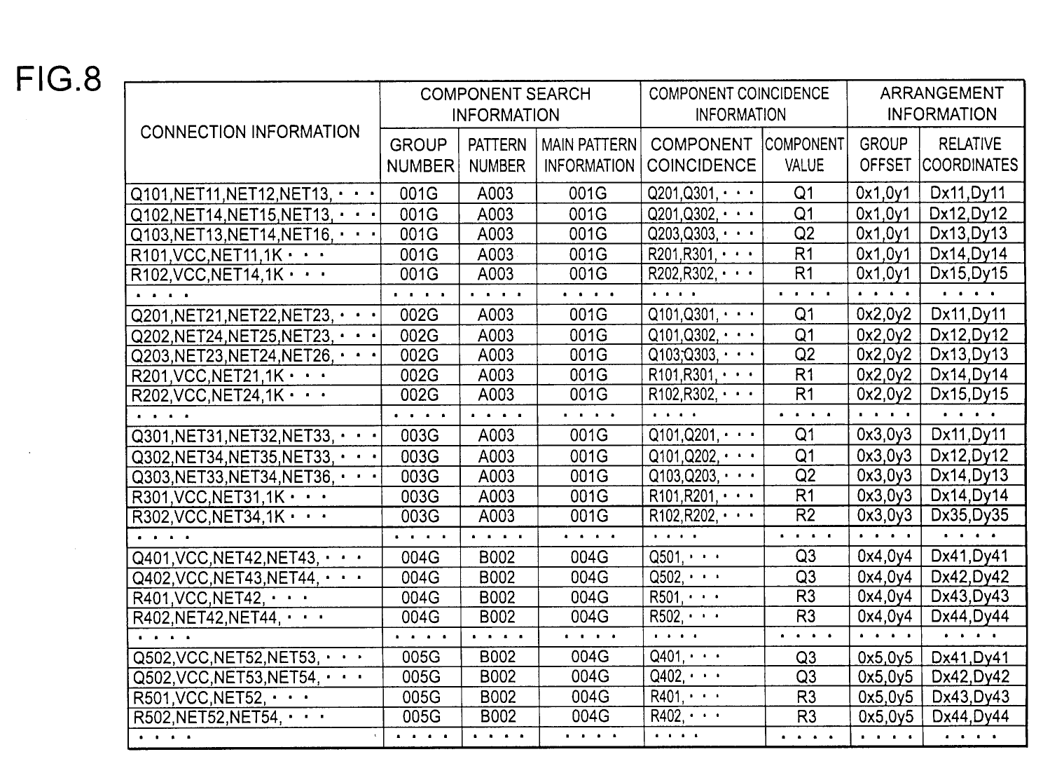

FIG. 8 depicts a diagram showing the list of group composition information including group circuit connection information when the processing flow of FIG. 7 is applied to the above-described circuit of FIG. 1. The list of the group composition information 12 shown in FIG. 8 is made up of component connection information, component search information, component coincidence information and arrangement information.

For example, connection information including a transistor Q101 has search information including a group number 001G, a pattern number A003 and main pattern information 001G. Furthermore, this connection information has component coincidence information made up with component coincidence of transistors Q201, Q301 and a component value of a transistor Q1. Furthermore, this connection information has arrangement information regarding a group offset of 0x1, 0y1 and relative coordinates of Dx1, Dy1. Incidentally, although this explanatory view relates bipolar transistors, similar effects are obtained in other components such as MOS transistors.

Next, the method for making layout data in a semiconductor integrated circuit of the first embodiment of the invention will be described in detail. As shown in the processing flow of FIG. 7, first, in the process of group dividing 101, the flat circuit diagram data 11 is divided into groups for each repeated pattern and the group composition information 12 is made. The group composition information 12 has connection information on main patterns, replicated patterns of the main patterns and other patterns (the column “connection information” of FIG. 8), search information (the column “group number” , column “pattern number” and column “main pattern information” of FIG. 8) and component coincidence information (the column “component coincidence” and column “component value” of FIG. 8).

Subsequently, in the step 102, whether a group is main patterns is judged. In the case of main patterns, the connection information of only main patterns is extracted by the process of extraction of main pattern connection information 103 (main pattern connection information 13). Subsequently, layout cell data corresponding to the main patterns (main pattern layout data) is generated by use of the net driven layout editor 104 and outputted as the group layout data 14. Subsequently, the resultant arrangement information is extracted by the process of main pattern arrangement information 105 and added to the group composition information 12 (the column “group offset” and column “relative coordinates” of FIG. 8).

Subsequently, when it is judged in the step 102 that the group is replicated patterns, the main pattern layout data which has been generated from the group layout data 14 is extracted by the process of extraction of main pattern layout 106. Subsequently, in the process of coordinate offset 107, the group is arranged on the group layout data 14 as replicated pattern layout data at the same hierarchical level as the main pattern layout data by shifting the arrangement coordinates.

Furthermore, in the process of connection information substitution 108, the replicated pattern connection information extracted from the group composition information 12 is substituted for the connection information of the replicated pattern layout data which has been previously arranged on the group layout data 14. Subsequently, in the step 109 it is judged whether the composition of the replicated patterns (connection information) is similar to the composition of the main patterns (connection information) in terms of different component values etc. In the case of a similar composition, relevant areas of the replicated pattern layout data are edited in the process of editing of replicated pattern layout 110 by use of the net driven layout editor 104 etc.

Subsequently, in the process of extraction of replicated pattern arrangement information 111, the arrangement information of the replicated pattern layout data is extracted and added to the group composition information 12 (the column “group offset” and column “relative coordinates” of FIG. 8). Incidentally, in the branch from the step 102, the processing of main patterns (from the process of extraction of main pattern connection information 103 to the process of extraction of main pattern arrangement information 105) is preferentially carried out with respect to the processing of replicated patterns (from the process of extraction of main pattern layout 106 to the process of extraction of replicated pattern arrangement information 111) and other processing.

Incidentally, the values of “relative coordinates” of replicated patterns are the same as those of main patterns. Furthermore, an actual arrangement coordinate value is equal to a value obtained by the addition of a “group offset” value and a “relative coordinates” value. Furthermore, the “group offset” value of each replicated pattern differs from a replicated pattern to another. The above processing is carried out until all patterns of all groups are completed (the process 112). Lastly, in the process of layout composition 113, remaining patterns (other than the main patterns and replicated patterns) are made and composed with respect to the group layout data 14 by the net driven layout editor etc. and outputted as the layout data 15.

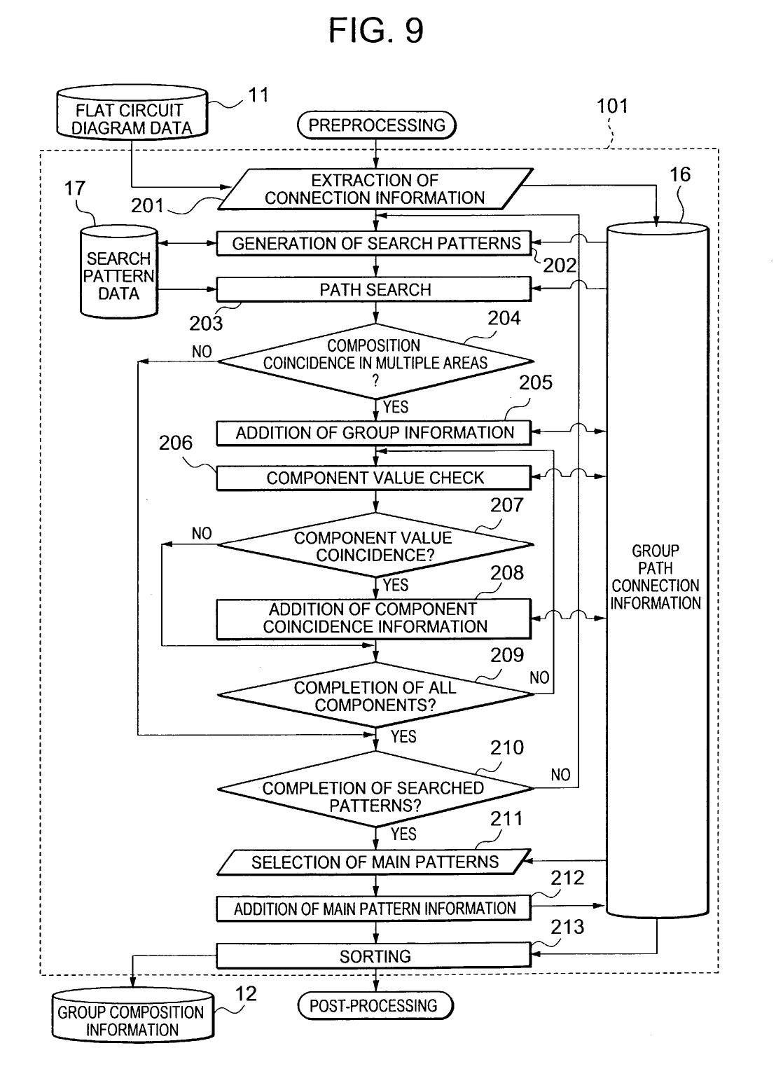

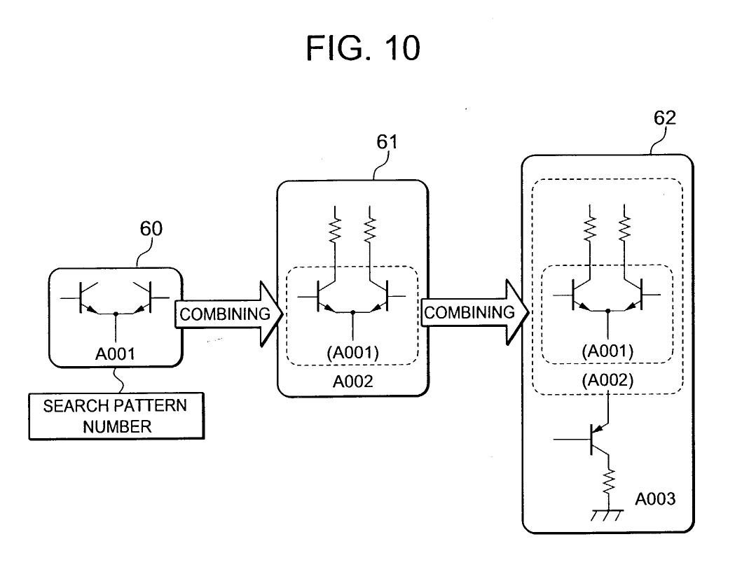

FIG. 9 depicts a detailed processing flow chart of the process of group dividing 101 of FIG. 7. First, in the process of group dividing 101, connection information is extracted by the process of connection information 201 from the flat circuit diagram data 11 and outputted to the group circuit composition information 16. FIG. 8 depicts also the contents of the group circuit composition information 16. Incidentally, FIG. 10 depicts also a diagram of an example of search pattern data to the above-described FIG. 1 and illustrates how path search is performed by combining search patterns in an example in which the processing flows from a search pattern number A001 (number 60 including a differential transistor) through a search pattern number A002 (number 61 obtained by adding a resistor to the number 60) to A003 (number 62 obtained by adding a transistor and a resistor to the number 61).

Subsequently, in the process of search pattern generation 202, search pattern data 17 is generated and then in the process of path search 203, a pattern whose composition coincides with the search pattern data is searched from the group circuit connection information 16. This method is a circuit search mechanism which extracts similar patterns from a circuit by use of pattern matching. This process of path search 203 is a publicly known technique and disclosed as a “circuit search method” in the Japanese Patent Laid-Open No. 01-017158, for example.

Subsequently, when it is judged in the step 204 that coincidence of composition exists in multiple areas, group information is added by the process of addition of group information 205. That is, a group number (the column “group number” of FIG. 8 (numerical-alphabetical columns such as “001G” and “002G”)) and a pattern number indicative of which search pattern the coincidence has been obtained by (the column “pattern number” of FIG. 8 (numerical-alphabetical columns such as “A003” and “B002)) are added to each piece of connection information (pattern data) of the group circuit connection information in coincidence with the search pattern.

Subsequently, component value checking of all corresponding components among groups is carried out in the process of component value check 206. In the case of coincidence of component values (207), component coincidence information is added to the components of the group circuit connection information 16 (the process of addition of component incidence information208) . More specifically, the component coincidence information is the column “component coincidence” of FIG. 8 (component numbers whose composition for connection such as “Q201, Q301 . . . ” is coincident are enumerated ) and the column “component value” of FIG. 8 (the same numerical-alphabetical columns indicative of the coincidence of component value such as “Q1” and “R1”).

In the search pattern data used in the above-described processing, the process of path search 203 is repeatedly performed by use of the search pattern data combined in the process of search pattern generation 202 until the connection nodes reach a power source or ground. Incidentally, search pattern data which overlap each other are not generated or alternatively the processing is finished at the process of path search 210. If areas in coincidence by use of new search pattern data contain areas which has been in coincidence by use of the last search pattern, in the process of addition of group information 205 updating is performed to group information corresponding to the new search pattern data. Incidentally, a basic pattern such as the configuration of a differential circuit, a pattern randomly selected from the group circuit connection information, a pattern designated by the user and a combination of these patterns are conceivable as the initial value of search pattern data.

Subsequently, in the process of selection of main patterns 211, pattern data which becomes main pattern data is selected from the group of the pattern data in coincidence in terms of the same pattern from the group circuit connection information 16. In the process of addition of main pattern information 212, the group number of main pattern data is added as main pattern information (the column “main pattern information” of FIG. 8) to each pattern data in coincidence in terms of the same pattern. Incidentally, pattern data which is in coincidence in terms of main pattern information and its own group number becomes main pattern information, pattern data not in coincidence becomes replicated pattern data, and pattern data having no group number becomes other pattern data. Incidentally, pattern data which is first found in the process of path search, pattern data having the maximum component value, pattern data having the largest number of component values in coincidence, etc. are conceivable as the conditions for selection as main pattern data.

Lastly, in the process of sorting 213, each pattern data of the group circuit connection information 16 (FIG. 8) is sorted by pattern number and main pattern information, and outputted as the group composition information 12.

(Second Embodiment)

Next, a method for making layout data in a semiconductor integrated circuit of the second embodiment of the invention will be described.

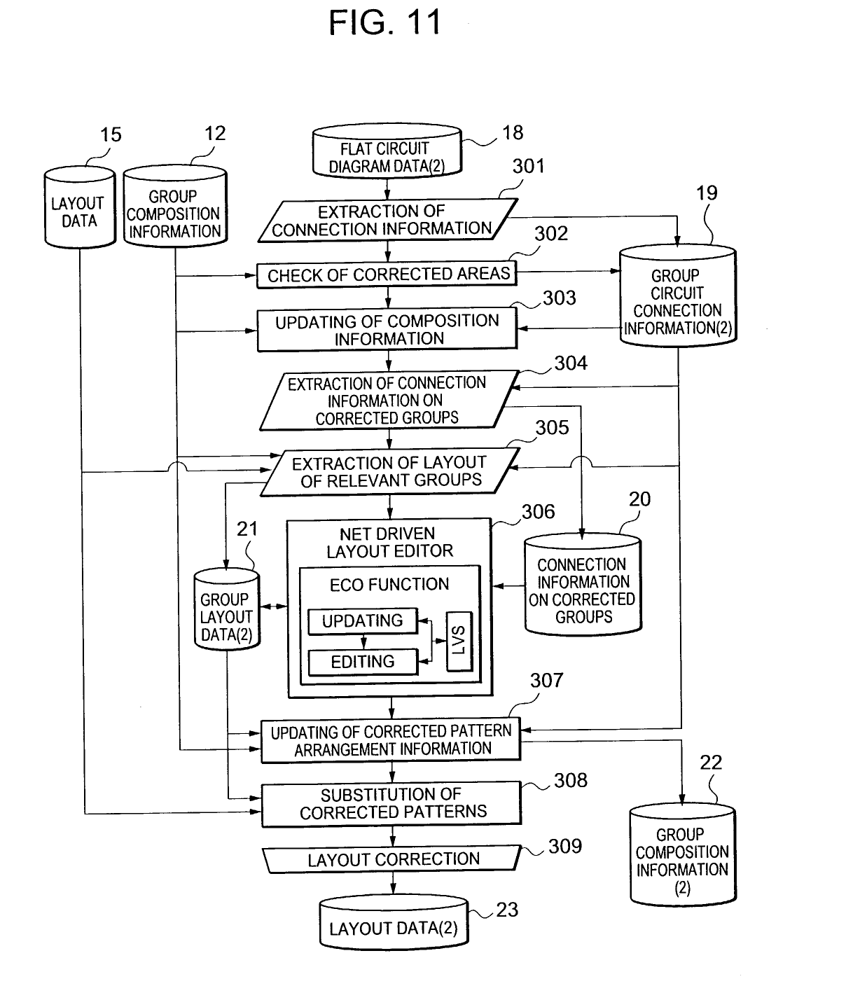

FIG. 11 depicts a processing flow chart of the method for making layout data in a semiconductor integrated circuit of the second embodiment of the invention and this flow chart relates to a circuit correction. First, the layout data 15 and group composition information 12 made in the first embodiment and flat circuit diagram data (2) 18 subjected to a circuit correction are inputted, and corrected areas are checked by use of the connection information of this flat circuit diagram data (2) 18 and the group composition information 12, and group circuit connection information (2) 19 in which the connection information. on corrected areas is updated is obtained (the process of extraction of connection information 301, the process of check of corrected areas 302, the process of updating of composition information 303).

Subsequently, in the process of extraction of connection information of corrected groups 304, connection information on groups corresponding to corrected areas is extracted from the group circuit connection information (2) 19 and outputted to connection information on corrected groups 20. Next, in the process of extraction of pertinent group layout 305, by referring to the group composition information 12 and group circuit connection information (2) 19, layout data corresponding to corrected areas is extracted from the layout data 15 and output to group layout data (2) 21.

Subsequently, by use of the process of ECO 306 of the net driven layout editor, the updating of the group layout data (2) 21 is. performed from the corrected group connection information 20. And in the process of substitution of corrected patterns 308, the updated group layout data (2) 21 is substituted for pertinent areas of the layout data, and layout data (2) 23 is obtained by performing the process of layout correction 309. Incidentally, ECO is an abbreviation for “engineering change orders” and refers to the function of automatically correcting the layout data side in response to changes of component values etc. of a circuit diagram. This is a feature extension which a net driven layout editor generally has.

For the group composition information 12, in the process of updating of corrected pattern arrangement information 307, the group composition information (2) 22 is obtained by up dating arrangement information based on the group circuit connection information (2) 19 and group layout data (2) 21. Incidentally, even in the case of a circuit correction, consistency is maintained among the circuit diagram data, the group composition information and layout data.

(Third Embodiment)

Next, a method for making layout data in a semiconductor integrated circuit of the third embodiment of the invention will be described.

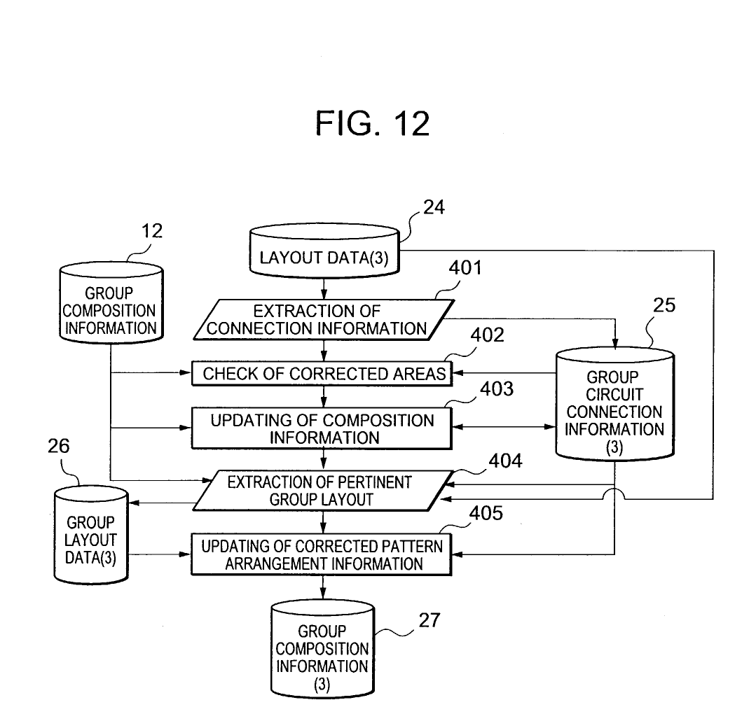

FIG. 12 depicts a processing flow chart of the method for making layout data in a semiconductor integrated circuit of the third embodiment of the invention and this flow chart relates to a circuit correction. It is assumed that this layout data correction is an arrangement change alone and does not cover a correction in the configuration of the circuit.

First, in the method for making layout data in a semiconductor integrated circuit of the third embodiment of the invention, the group composition information 12 made in the first or second embodiment and layout data (3) for which a layout data correction has been made by a method other than the method of the present invention. Subsequently, in the process of extraction of connection information 401, group circuit connection information (3) 25 having connection information of the layout data (3) 24 is taken out, and the checking of corrected areas with respect to the group composition information 12 is performed (the process of check of corrected areas 402). And the process of updating of composition information 403 is performed by updating composition information of arrangement coordinates etc. of the group circuit connection information (3) 25.

Next, in the method for making layout data in a semiconductor integrated circuit of the third embodiment of the invention, in the process of extraction of pertinent group layout data 404, by referring to the group composition information 12 and group circuit connection information (3) 25, layout data corresponding to corrected areas is extracted from the layout data (3) 24 and outputted to group layout data (3) 26.

Lastly, in the method for making layout data in a semiconductor integrated circuit of the third embodiment of the invention, for the group composition information 12, in the process of updating of corrected pattern arrangement information 405, arrangement information is updated from the group circuit connection information (3) 25 and group layout data (3) 26, and group composition information (3) 27 is obtained. Incidentally, even in the case of a circuit correction, consistency is maintained among the circuit diagram data, the group composition information and layout data.

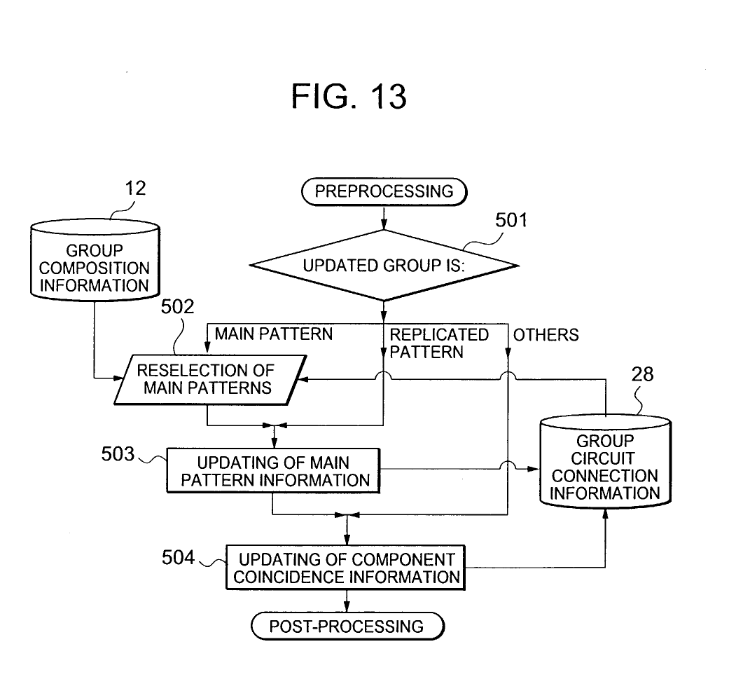

FIG. 13 depicts a detailed processing flow chart of the process of updating of composition information (303) of the second embodiment and the process of updating of composition information (403) of the third embodiment. First, the process of updating of composition information (303) of the second embodiment will be described. Group circuit connection information 28 corresponds to the group circuit connection information (2) (reference numeral 19 of FIG. 11). In the process of updating of composition information (303) of the second embodiment, when a group corrected in the flat circuit diagram data (2) (reference numeral 18 of FIG. 11) subjected to a circuit correction has been on a main pattern side, this case may not sometimes apply to the “conditions for the selection as main pattern data” in the previously explained process of group dividing (FIG. 9). Therefore, in the same manner as with the process of selection of main patterns 211 and addition of main pattern information 212 described in FIG. 9, in the process of reselection of main patterns 502 a new main pattern is selected from the group composition information 12 and group circuit connection information 28, and the group circuit connection information 28 is updated in the process of updating of main pattern information 503. Furthermore, in the same manner as with the process of addition of component coincidence information (206 to 211) described in FIG. 9, in the process of updating of component coincidence information 504 component coincidence information is made anew from the group composition information 12 and group circuit connection information 28, and the group circuit connection information 28 is thus updated. Incidentally, this process of updating is performed for all patterns.

Next, when a group corrected in the flat circuit diagram data (2) (reference numeral 18 of FIG. 11) subjected to a circuit correction was on a main pattern side (“corrected pattern” of 502), it is necessary correct with the main pattern information and component coincidence information (FIG. 8). In the process of updating of main pattern information 503 and the process of updating of component coincidence information 504, the main pattern information and component coincidence information of the pertinent replicated pattern are made anew according to the contents of the pertinent correction (the information of the group circuit connection information 28) and the group circuit connection information 28 is thus updated.

Next, when in the flat circuit diagram data (2) (reference numeral 18 of FIG. 11) subjected to a circuit correction the main pattern and the replicated pattern had the same contents of correction, it is unnecessary to correct the main pattern information, whereas a correction may sometimes be necessary for the component coincidence information (the column “component value” of FIG. 8) within the component coincidence information. In this case, in the process of updating of component value coincidence information 504, component coincidence information is made anew from the group composition information 12 and group circuit connection information 28, and the group circuit connection information 28 is thus updated.

Incidentally, when in the flat circuit diagram data (2) (reference numeral 18 of FIG. 11) the main pattern and the replicated pattern had different contents of correction, processing thereafter is performed according to the contents of correction separately in the case where the correction was only on the main pattern side (“main pattern” of 501) and in the case where the correction was on the replicated pattern side (“replicated pattern” of 502).

Next, the process of updating of composition information (403) of the third embodiment will be described. The process of updating of composition information (403) of the third embodiment is the same as the processing in the above-described second embodiment with the exception that the group circuit connection information 28 corresponds to the group circuit connection information (3) (reference numeral 25 of FIG. 12). Therefore, a detailed description is omitted.

(Fourth Embodiment)

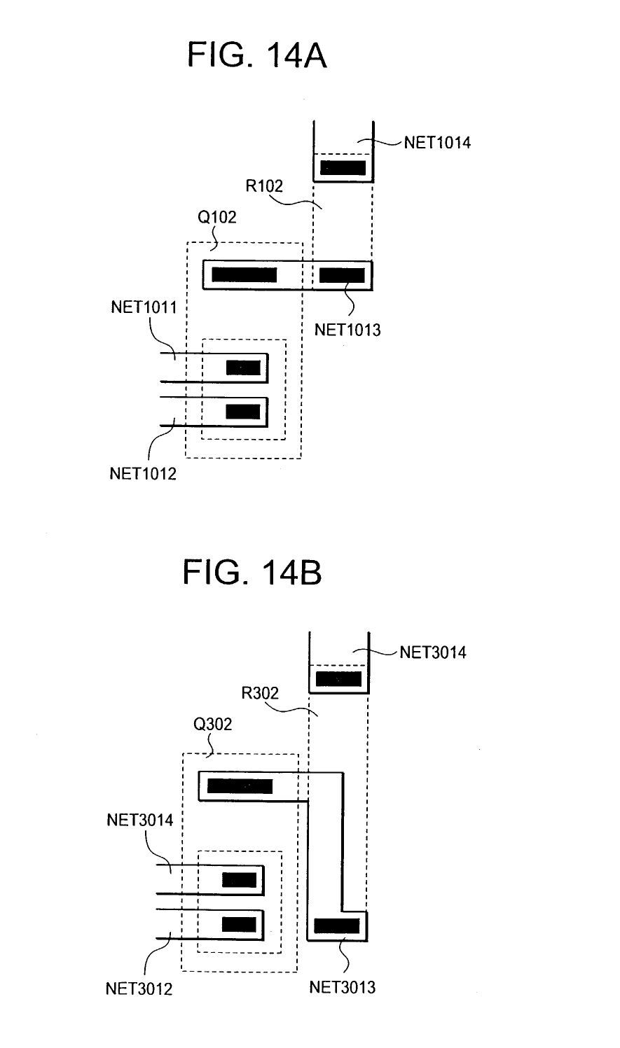

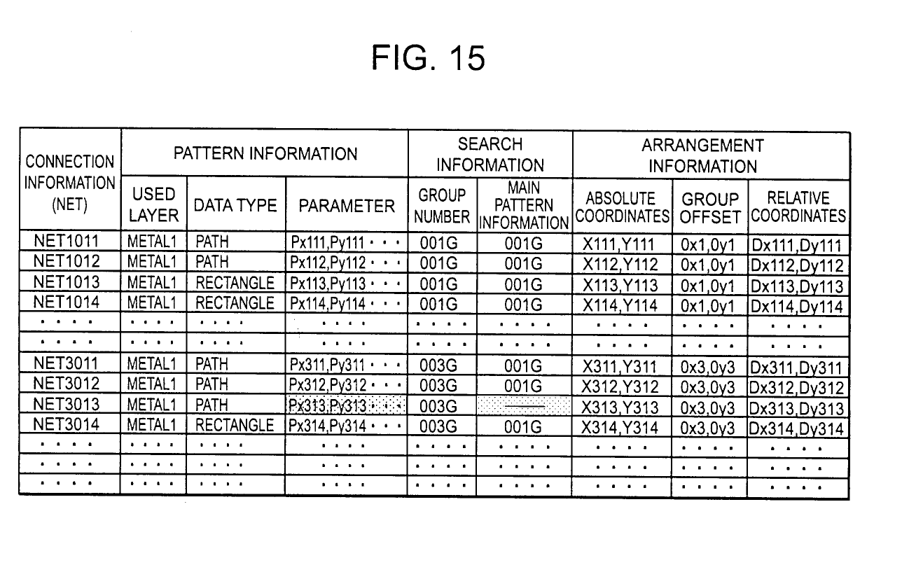

FIGS. 14A and 14B each depict a layout plan to explain the method for making layout data in a semiconductor integrated circuit of the fourth embodiment of the invention. The figures show an example in which the size in layout data differs due to a difference in the resistance value between a resistor R102 and a resistor R302. Arrangement information of graphic data other than components, such as wiring, is added to the above-described group composition information 12 (FIG. 7) or group composition information (2) 22 (FIG. 11) and group composition information (3) 27 (FIG. 12). More specifically, connection information on individual graphic data (NET 1011, NET1012, . . .) and each piece of pattern information, i.e., used layer (Metal, . . .), data type (Path, Rectangle, . . and parameter (Px111, Py111, . . .) are added (addition of the contents of FIG. 15). As a result of this, it becomes possible to maintain consistency among the circuit diagram data, the group composition information and layout data more precisely and flexibly than in the above-described embodiments. Incidentally, equivalent effects can be obtained also in cell data the size of which differs due to a difference in component value.

In terms of the explanatory views illustrating examples of graphic data other than components, such as wiring, shown in FIGS. 14 (A) and 14(B), these are examples showing layout data corresponding to the transistor Q102 and resistor R102 of the block 51, which is part of the wiring of FIG. 1, ( “001G” of the column “group number” of FIG. 8 corresponds to the main pattern side of FIG. 14 (A)) and the transistor Q302 and resistor 302 of the block 53 (“003G” of the “group number” of FIG. 8 corresponds to the replicated pattern side).

Because the resistor R302 has a component value different from the resistor R102 on the main pattern side, the component size of the resistor R320 differs in layout data. For this reason, it follows that the graphic data of the wiring which connects to the resistor R302 (NET3013) differs from the graphic data on the main pattern side (Net1013) in shape etc.

In this case, the main pattern information of the graphic data of group composition information (Net3013) is left blank, for example, (the “NET3013” line and column “main pattern information” of FIG. 15 correspond to NET3013 of FIG. 14 (B)) As a result of this, because it becomes possible to make discrimination from the graphic data on the main pattern side (NET1013) in that the shape is different, it becomes possible to perform the same processing as in the above-described embodiments. Hence, effects similar to those of the above-described embodiments can be obtained.

The fact that the group composition information in this case contains the contents shown in FIG. 8 and the contents shown in FIG. 15 (graphic data arrangement information) will be described below.

First, for the first embodiment, processing, which involves extracting the arrangement information of graphical data on the main pattern side and outputting this arrangement information to the group composition information 12, is added to the process of extraction of main pattern arrangement information 105 of FIG. 7. Furthermore, processing which involves substituting the connection information of each graphical data included in the graphical data on the replicated pattern side within the group composition information 12 for the connection information of replicated pattern layout data is added to the process of substitution of connection information 108.

Furthermore, processing, which involves extracting the pattern information included in the arrangement information of graphical data as the arrangement information of replicated pattern layout data and adding this pattern information to the group composition information 12, is added to the process of extraction of replicated pattern arrangement information 111. Moreover, processing, which involves not adding main pattern information to the graphical data of wiring which connects to components on the replicated pattern side having component values different from those on the main pattern side (the column “NET3013” and the column “main pattern information” of FIG. 15 correspond to NET3013 of FIG. 14 (B)), is added to the process of addition of main pattern information 212 of FIG. 9.

As a result of the foregoing, even in a case where in circuit diagram data having repeated patterns component values are different within the same pattern, it becomes possible to make flat layout data by making replicated patterns by the replication of main patterns and hence it becomes possible to obtain effects similar to those of the first embodiment.

Also, for the second embodiment, the arrangement information of graphical data is included in the group composition information 12 of FIG. 11 due to the processing added to the first embodiment (FIGS. 7 and 9), and processing which involves obtaining the group composition information (2) 22 by updating the arrangement information of graphical data from the group circuit connection information (2) 19 and group layout data (2) 21 is added to the process of updating of replicated pattern arrangement information 307.

As a result of the foregoing, even in a case where in circuit diagram data having repeated patterns component values are different within the same pattern, it becomes possible, as with the second embodiment, to maintain consistency among the circuit diagram data, the group composition information and layout data for a correction on the circuit diagram side.

Furthermore, for the third embodiment, the arrangement information of graphical data is included in the group composition information 12 of FIG. 12 due to the processing added to the above-described FIGS. 7 and 11, and processing, which involves obtaining the group composition information (3) 27 by updating the arrangement information of graphical data based on the group circuit connection information (3) 25 and group layout data (3) 26, is added to the process of updating of replicated pattern arrangement information 405.

As a result of the foregoing, even in a case where in circuit diagram data having repeated patterns component values are different within the same pattern, it becomes possible, as with the third embodiment, to maintain consistency among the circuit diagram data, the group composition information and layout data for a correction on the circuit diagram side.

(Fifth Embodiment)

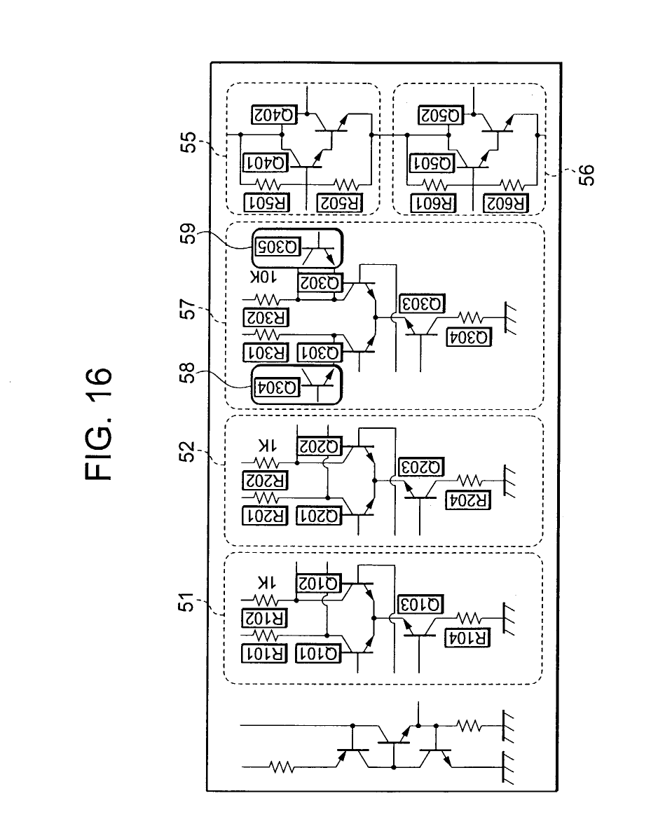

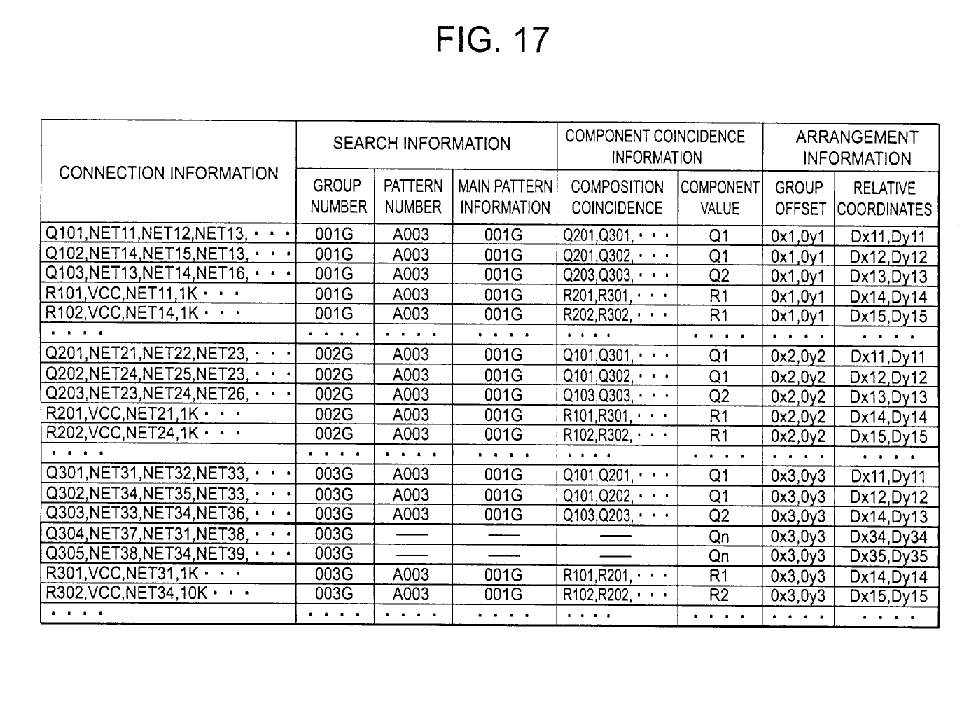

FIG. 16 depicts a circuit diagram to explain a method for making layout data in a semiconductor integrated circuit of the fifth embodiment of the invention. Even in a pattern which is partially different from the search pattern of the above-described group composition information (Q304 (58) and Q305 (59) of FIG. 16), by adding the same group number as in FIG. 17, it becomes possible to obtain perform the same processing as in the above-described embodiments and hence to obtain effects similar to those of the above-described embodiments.

The group composition information in this case has the contents shown in FIG. 17, not the previously shown contents of FIG. 8. Furthermore, this group composition information also has the contents of FIG. 15 in a case where it also has the functions of the above-described fourth embodiment.

First, for the first embodiment (FIG. 7), in a case where a pattern which is partially different from the search pattern is contained in the main pattern, in the method for making layout data in a semiconductor integrated circuit of the fifth embodiment of the invention, processing which includes extracting the arrangement information on a pattern which is partially different and outputting this information to the group composition information 12 is added to the process of extraction of main pattern arrangement information 105. On the other hand, in a case where a pattern which is partially different from the search pattern is included in the replicated pattern, processing, which involves substituting the connection information contained in the arrangement information on a partially different pattern on the replicated pattern side within the group composition information 12 for the connection information of replicated pattern layout data, is added to the process of substitution of connection information 108. Furthermore, processing, which involves extracting the arrangement information on a partially different pattern as the arrangement information of replicated pattern layout data and adding this arrangement information to the group composition information 12, is added to the process of extraction of replicated pattern arrangement information 111. Furthermore, at the time of judgment as to whether composition coincidence exists in multiple areas (204) in FIG. 9, processing, which involves judging that even a pattern partially different from the search pattern is coincident and adding only a group number as group information to the partially different pattern, is added to the process of addition of group information 205 (in this case, a pattern number is not added. The “Q304” line, “Q305” line and column “pattern number” of FIG. 17 correspond to this processing). Moreover, in order to show that coincidence with others does not exist, processing which involves adding a component value which is an independent value (corresponding to the column “component value” of FIG. 17) is added to the process of component coincidence information 208, and processing which involves not adding main pattern information to the partially different pattern (corresponding to the column “main pattern information” of FIG. 17) is added to the process of addition of main pattern information 212.

As a result of the foregoing, even in a case where in circuit diagram data having repeated patterns their compositions are partially different within the same pattern, it becomes possible to make flat layout data by replicated patterns made by replicating main patterns and hence it becomes possible to obtain effects similar to those of the first embodiment.

For the second embodiment, the arrangement information of graphical data is included in the group composition information 12 due to the above-described processing added to the first embodiment (FIGS. 7 and 8). Therefore, processing, which involves obtaining the group composition information (2) 22 by updating the arrangement information of graphical data from the group circuit connection information (2) 19 and group layout data (2) 21, is added to the process of updating of corrected pattern arrangement information 307.

Furthermore, for the second embodiment, the arrangement information of a partially different pattern is included in the group composition information 12 of FIG. 11 due to the processing added to the above-described first embodiment (FIGS. 7 and 8), and processing, which involves obtaining the group composition information (2) 22 by updating the arrangement information on the partially different pattern based on the group circuit connection information (2) 19 and group layout data (2) 19, is added to the process of updating of corrected pattern arrangement information 307.

As a result of the foregoing, even in a case where, in a circuit having repeated patterns, their compositions are partially different within the same pattern, it becomes possible, as with the second embodiment, to maintain consistency among the circuit diagram data, the group composition information and layout data for a correction on the circuit diagram side.

For the third embodiment, the arrangement information of a partially different pattern is included in the group composition information 12 of FIG. 12 due to the processing added to the above-described first embodiment (FIGS. 7 and 8), and processing, which involves obtaining the group composition information (3) 27 by updating the arrangement information on the partially different pattern from the group circuit connection information (3) 25 and group layout data (3) 26, is added to the process of updating of corrected pattern arrangement information 405.

As a result of the foregoing, even in a case where, in a circuit having repeated patterns, their compositions are partially different within the same pattern, it becomes possible, as with the third embodiment, to maintain consistency among the circuit diagram data, the group composition information and layout data for a correction on the circuit diagram side.

As described above, according to the features of the present invention, circuit diagram data having repeated patterns is divided by the process of group dividing into main patterns and replicated patterns, and relations of each of the patterns are held as group composition information. Layout data corresponding to replicated patterns (replicated pattern layout data) is made by copying layout data corresponding to the main patterns made by a net driven layout editor (main pattern layout data). By further performing the process of coordinate offset arrangement, the replicated pattern layout data is arranged on the same hierarchical level as the main pattern layout data.

As a result, it is possible to make layout data with the flat circuit diagram data kept as it is. Therefore, it is possible to check the flow of electrical signals on each component and wiring at the same hierarchical level. That is, it becomes easy to grasp the action of the whole circuit (particularly, in an analog system) and besides even in flat layout data made from circuit diagram data having repeated patterns, replicated patterns can be made by replicating main patterns.

Furthermore, by updating the connection information of replicated pattern layout data to the connecting information of replicated pattern (on the circuit diagram data side), the replicated pattern layout data is made equivalent to the making of such data by use of the net driven layout editor. Therefore, even in layout data made from flat circuit diagram data, redundant work becomes unnecessary for the making of repeated pattern areas on one side and the mutually contradictory conventional problem does not exist any more, thus providing advantages.

What is claimed is:

1. A method for making layout data in a semiconductor integrated circuit, comprising:
group dividing process for dividing circuit diagram data having repeated patterns into main patterns and replicated patterns and for outputting relations of each of the main patterns and the replicated patterns as group composition information formed by connection information of the constituent components, search information of the constituent components, component coincidence information of the constituent components and arrangement information of the constituent components for each of the constituent components included in the circuit diagram data;
identification process for identifying the main patterns, the replicated patterns and others from the group composition information;
main pattern layout data making process for making main pattern layout data made by use of a net driven layout editor corresponding to main patterns in a case where the group composition information is the main patterns; and
replicated pattern layout data making process for making replicated pattern layout data corresponding the replicated patterns by copying the main pattern layout data corresponding to the main patterns made by the net driven layout editor in a case where the group composition information is the replicated patterns.

2. The method for making layout data in a semiconductor integrated circuit according to claim 1, wherein the group dividing further comprises:
the process of adding group information (207);
the process of adding component coincidence information (210);
the process of selecting main patterns (213); and
the process of adding main pattern information (214).

3. The method for making layout data in a semiconductor integrated circuit according to claim 1, wherein replicated pattern layout data corresponding to the replicated patterns is made by copying main pattern layout data corresponding to the main patterns made by the net driven layout editor, and connection information on the side of the replicated pattern layout data from this group composition information is updated to replicated pattern connection information on the circuit diagram data side

4. The method for making layout data in a semiconductor integrated circuit according to claim 1, further comprising:
offset arrangement process for arranging the replicated pattern layout data in the same hierarchical position as the main pattern layout data by shifting the coordinates thereof.

5. The method for making layout data in a semiconductor integrated circuit according to claim 3, further comprising:
offset arrangement process for arranging the replicated pattern layout data in the same hierarchical position as the main pattern layout data by shifting the coordinates thereof.

6. The method for making layout data in a semiconductor integrated circuit according to claim 1, further comprising:
the process for correcting and updating the group composition information using an ECO function by the net driven layout editor even during a circuit correction by including also connection information of each pattern in the group composition information.

7. The method for making layout data in a semiconductor integrated circuit according to claim 3, further comprising:
the process for correcting and updating the group composition information using an ECO function by the net driven layout editor also during a circuit correction by including also connection information of each pattern in the group composition information.

8. The method for making layout data in a semiconductor integrated circuit according to claim 1, wherein consistency is maintained among the circuit diagram data, the group composition information and layout data by including arrangement coordinates in the group composition information, and the ECO function of correction and update is used by use of the net driven layout editor during a layout correction.

9. The method for making layout data in a semiconductor integrated circuit according to claim 3, wherein consistency is maintained among the circuit diagram data, the group composition information and layout data by including arrangement coordinates in the group composition information, and the ECO function of correction and update is used by use of the net driven layout editor during a layout correction.

10. The method for making layout data in a semiconductor integrated circuit according to claim 1, wherein, by including arrangement information of wiring and the like other than components in the group composition information, the ECO function of correction and update is used by use of net driven layout editor also in cell data of different sizes.

11. The method for making layout data in a semiconductor integrated circuit according to claim 3, wherein, by including arrangement information of wiring and the like other than components in the group composition information, the ECO function of correction and update is used by use of net driven layout editor also in cell data of different sizes.

12. The method for making layout data in a semiconductor integrated circuit according to claim 1, wherein by adding the same group number to the group composition information also in patterns which are partly different from the search patterns, the ECO function of correction and update is used by use of net driven layout editor also in patterns on the side of circuit diagram data whose composition is partly different.

13. The method for making layout data in a semiconductor integrated circuit according to claim 3, wherein by adding the same group number to the group composition information also in patterns which are partly different from the search patterns, the ECO function of correction and update is used by use of net driven layout editor also in patterns on the side of circuit diagram data whose composition is partly different.
